(19) United States
(12) Patent Application Publication
(10) Pub. No.: US 2024/0247772 A1
(43) Pub. Date: Jul. 25, 2024

(54) VEHICLE LIGHTING DEVICE AND VEHICLE LIGHTING FIXTURE

(71) Applicant: Toshiba Lighting & Technology Corporation, Kanagawa (JP)

(72) Inventor: Tomohiro Matsuo, Ehime-ken (JP)

(73) Assignee: Toshiba Lighting & Technology Corporation, Kanagawa (JP)

(21) Appl. No.: 18/449,648

(22) Filed: Aug. 14, 2023

(30) Foreign Application Priority Data
Jan. 19, 2023 (JP) 2023-006738

(51) Int. Cl. F21S 41/19; F21S 41/143; F21S 41/20; F21S 41/32

(52) U.S. Cl. CPC F21S 41/192; F21S 41/143; F21S 41/28; F21S 41/321

(57) ABSTRACT

A vehicle lighting device includes: a socket; a substrate, provided on a side of an end part of the socket; light-emitting elements, provided on the substrate; a frame part, having a frame shape, provided on the substrate, and surrounding the light-emitting elements; and a sealing part, provided on an inner side of the frame part and covering the light-emitting elements. When viewing from a direction along a central axis of the vehicle lighting device, a profile of the frame part is square or circular. If the profile of the frame part is square, a dimension of a side on the inner side of the frame part is 3.2 mm or more and 4.8 mm or less. If the profile of the frame part is circular, an inner diameter of the frame part is 4.5 mm or more and 6.8 mm or less.

### CROSS-REFERENCE TO RELATED APPLICATION

This application claims the priority benefit of Japan application serial No. 2023-006738, filed on Jan. 19, 2023. The entirety of the above-mentioned patent application is hereby incorporated by reference herein and made a part of this specification.

### BACKGROUND

### Technical Field

Embodiments of the invention relate to a vehicle lighting device and a vehicle lighting fixture.

### Description of Related Art

From the perspective of reducing power consumption, increasing service time, etc., in place of a vehicle lighting device including a lamp having a filament, a vehicle lighting device including a light-emitting element such as a light emitting diode has become more popular. The vehicle lighting device including the light-emitting element is installed to a housing of a vehicle lighting fixture. In addition, in the vehicle lighting fixture, an optical element, such as a reflector, is provided. The optical element provided in the vehicle lighting fixture makes use of the light emitted from the vehicle lighting device, and is designed to obtain a predetermined light beam, light distribution pattern, etc.

Here, the luminance distribution of a portion from which the light of the vehicle lighting device is emitted has a great influence on the optical design of the optical element provided in the vehicle lighting fixture.

Therefore, it is desired that a predetermined luminance distribution is exhibited in the vehicle lighting device.

### PRIOR ART DOCUMENT(S)

### Patent Document(s)

[Patent Document 1] Japanese Laid-open No. 2016-195099

### SUMMARY

A vehicle lighting device according to an embodiment includes: a socket; a substrate, provided on a side of an end part of the socket; multiple light-emitting elements, provided on the substrate; a frame part, having a frame shape, provided on the substrate, and surrounding the light-emitting elements; and a sealing part, provided on an inner side of the frame part and covering the light-emitting elements. In a case of viewing from a direction along a central axis of the vehicle lighting device, a profile of the frame part is square or circular. In a case where the profile of the frame part is square, a dimension of a side on the inner side of the frame part is 3.2 mm or more and 4.8 mm or less. In a case where the profile of the frame part is circular, an inner diameter of the frame part is 4.5 mm or more and 6.8 mm or less.

### BRIEF DESCRIPTION OF THE DRAWINGS

FIG. 1 is a schematic perspective view illustrating a vehicle lighting device according to an embodiment.

FIG. 2 is a cross-sectional view illustrating the vehicle lighting device and taken along a line A-A of FIG. 1.

FIG. 3 is a schematic plan view illustrating a portion of a light emitting module in which a frame part is provided in a case of viewing from a direction along the central axis of the vehicle lighting device.

FIG. 4 is a view illustrating evaluation of a luminance distribution of a portion from which light of the vehicle lighting device is emitted.

FIG. 5 is a schematic plan view illustrating a case where a frame part is provided on regions C1 to C20.

FIG. 6 is a schematic plan view illustrating a case where a profile of the frame part is circular.

FIG. 7 is a schematic partial cross-sectional view illustrating a vehicle lighting fixture.

### DESCRIPTION OF THE EMBODIMENTS

The invention provides a vehicle lighting device and a vehicle lighting fixture that can achieve a predetermined luminance distribution.

In the following, the embodiments are described with reference to the drawings. In addition, in the respective drawings, the same reference numerals are assigned to the same components, and detailed description thereof will be omitted as appropriate.

### (Vehicle Lighting Device)

A vehicle lighting device 1 according to the embodiment can be provided in an automobile, a railroad vehicle, etc. As the vehicle lighting device 1 provided in an automobile, for example, examples include those used for a front combination light (e.g., one in which a daytime running lamp (DRL), a position lamp, a turn signal lamp, etc., are combined appropriately) and a rear combination light (e.g., one in which a stop lamp, a tail lamp, a turn signal lamp, a back lamp, a fog lamp, etc., are combined appropriately). However, the purpose of the vehicle lighting device 1 is not limited thereto.

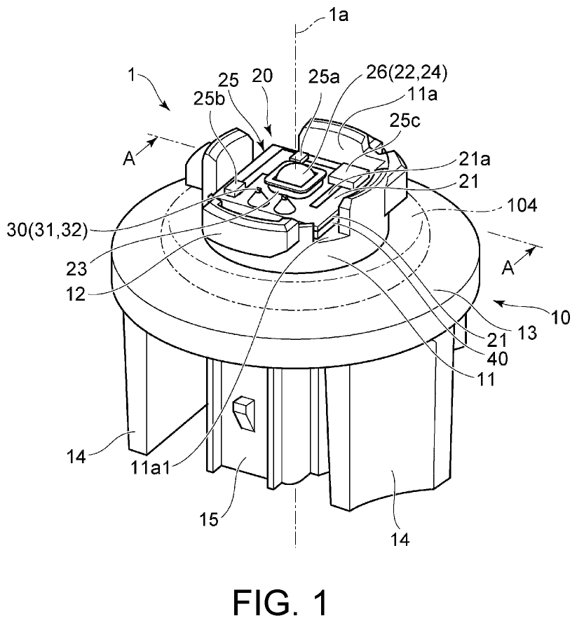

FIG. 1 is a schematic perspective view illustrating the vehicle lighting device according to an embodiment.

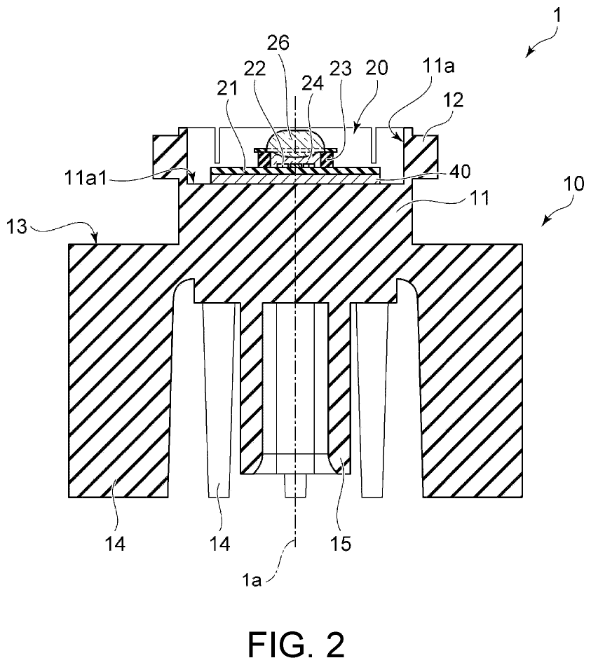

FIG. 2 is a cross-sectional view illustrating the vehicle lighting device 1 and taken along a line A-A of FIG. 1.

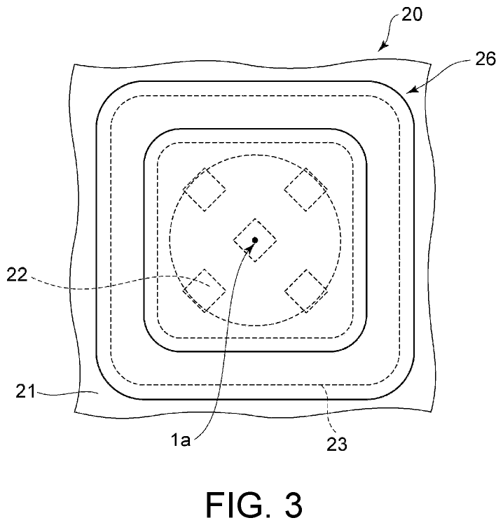

FIG. 3 is a schematic plan view illustrating a portion of a light emitting module 20 in which a frame part 23 is provided in a case of viewing from a direction along a central axis 1a of the vehicle lighting device 1.

As shown in FIGS. 1 and 2, the vehicle lighting device 1 is provided with a socket 10, a light emitting module 20, a power supply part 30, and a heat transfer part 40, for example.

The socket 10, for example, has an installation part 11, a bayonet 12, a flange 13, a heat dissipation fin 14, and a connector holder 15.

The installation part 11 is provided on a surface of the flange 13 on a side opposite to the side where the heat dissipation fin 14 is provided. The outer shape of the installation part 11 can be a columnar shape. The outer shape of the installation part 11, for example, is a cylindrical columnar shape. The installation part 11, for example, is provided with a concave part 11a open on an end part on a side opposite to the side of the flange 13.

The bayonet 12 is provided on a side surface of the installation part 11, for example. The bayonet 12 protrudes toward the outer side of the vehicle lighting device 1. The bayonet 12 is opposite to the flange 13. Multiple bayonets 12 can be provided. The bayonet 12 is used at the time of installing the vehicle lighting device 1 to a housing 101 of a vehicle lighting fixture 100 to be described afterwards, for example. The bayonet 12 can be used for twist lock.

The flange 13 is in a plate shape. The flange 13, for example, exhibits a substantially circular plate shape. A side surface of the flange 13 is located on the outer side of the vehicle lighting device 1 with respect to the side surface of the bayonet 12.

The heat dissipation fin 14 is provided on a side of the flange 13 opposite to the side of the installation part 11. At least one heat dissipation fin 14 can be provided. For example, as shown in FIGS. 1 and 2, multiple heat dissipation fins 14 can be provided on the socket 10. The heat dissipation fins 14 can be provided side-by-side in a predetermined direction. The heat dissipation fin 14, for example, exhibits a plate shape or a cylindrical shape.

The connector holder 15 is provided on a side of the flange 13 opposite to the side of the installation part 11. The connector holder 15 is provided side-by-side with the heat dissipation fin 14. The connector holder 15 exhibits a cylindrical shape, and a connector 105 having a seal member 105a is inserted into the connector holder 15.

The socket 10 has a function of holding the light emitting module 20 and the power supply part 30 and a function of transmitting the heat generated in the light emitting module 20 to the outside. Therefore, the socket 10 may be formed by a material having a high thermal conductivity. The socket 10, for example, can be formed from a metal such as aluminum alloy.

Also, in recent years, it is favored that the socket 10 is able to efficiently dissipate the heat generated in the light emitting module 20 and is light-weighted. Therefore, the socket 10, for example can be formed by a resin with a high thermal conductivity. The resin with a high thermal conductivity includes, for example, a resin, and a filler using an inorganic material. The resin with a high thermal conductivity is, for example, a resin formed by mixing a filler using carbon, aluminum oxide, etc., with a resin such as polyethylene terephthalate (PET), nylon, etc.

Assuming that the socket 10 includes the resin with a high thermal conductivity and the installation part 11, the bayonets 12, the flange 13, the heat dissipation fins 14 and the connector holder 15 are integrally molded in the socket 10, the heat generated in the light emitting module 20 can be efficiently dissipated. In addition, the weight of the socket 10 can be reduced. In such case, the installation part 11, the bayonets 12, the flange 13, the heat dissipation fins 14, and the connector holder 15 can be integrally formed by using injection molding. In addition, the socket 10, the power supply part 30, and the heat transfer part 40 can also be integrally formed by insert molding.

The light emitting module 20 (substrate 21) is provided on the side of an end part of the socket 10. For example, the light emitting module 20 is provided on the heat transfer part 40. The light emitting module 20, for example, has the substrate 21, a light-emitting element 22, a frame part 23, a sealing part 24, a circuit element 25, and a lens 26.

The substrate 21, for example, is adhered to the upper surface of the heat transfer part 40. In such case, an adhesive agent may be an adhesive agent with a high thermal conductivity. For example, the adhesive agent can be an adhesive agent in which a filler using an inorganic material is mixed.

The substrate 21 exhibits a plate shape. The planar shape of the substrate 21 (the shape in the case of viewing from the direction along the central axis 1a of the vehicle illumination device 1) is, for example, in a substantially rectangular shape. The substrate 21, for example, can be formed by an inorganic material such as ceramics (e.g., aluminum oxide or aluminum nitride), an organic material such as paper phenol or glass epoxy. In addition, the substrate 21 may also be a metal core substrate in which a surface of a metal plate is covered by an insulating material. In the case where the amount of heat generated by the light-emitting element 22 is high, from the perspective of heat dissipation, the substrate 21 may be formed by using a material with a high thermal conductivity. As a material with a high thermal conductivity, for example, examples include ceramics such as aluminum oxide and aluminum nitride, a resin with a high thermal conductivity, a metal core substrate. In addition, the substrate 21 may have a single-layer structure and may also have a multi-layer structure.

In addition, a wiring pattern 21a is provided on the surface of the substrate 21. The wiring pattern 21a is, for example, formed from a material with silver as the main component, a material with copper as the main component, etc. In addition, a cover part covering the wiring pattern 21a or a film resistor to be described afterwards can also be provided. The cover part, for example, can include a glass material.

The light-emitting element 22 is provided on the substrate 21 (on a surface of the substrate 21 on a side opposite to the side of the socket 10). The light-emitting element 22 is electrically connected with the wiring pattern 21a. Multiple light-emitting elements 22 can be provided. The light-emitting elements 22 can be connected in series.

The light-emitting elements 22, for example, can be provided at rotationally symmetrical positions with the central axis 1a of the vehicle lighting device 1 as the center. For example, as shown in FIG. 3, five light-emitting elements 22 can be provided. Also, in the case of viewing from the direction along the central axis 1a of the vehicle lighting device 1, it can be arranged that one of the light-emitting elements 22 is provided at the position of the central axis 1a of the vehicle lighting device 1, and four light-emitting elements 22 are provided at rotationally symmetrical positions with the central axis 1a of the vehicle lighting device 1 as the center. Accordingly, a luminance distribution to be described afterwards can be easily achieved. In such case, the four light-emitting elements 22 may be provided on a circumference having a diameter of 1.6 mm to 2.5 mm, with the central axis 1a of the vehicle lighting device 1 as the center.

The light-emitting element 22, for example, can be a light emitting diode, an organic light emitting diode, a laser diode, etc.

The light-emitting element 22 can be a chip-like light-emitting element. If the light-emitting element 22 is a chip-like light-emitting element, the size of the light emitting module 20 can be reduced, and the size of the vehicle lighting device 1 can be reduced. The chip-like light-emitting element 22 can be mounted to the wiring pattern 21a through chip-on-board (COB). The chip-like light-emitting element 22 may be any of an upper-electrode-type light-emitting element, an upper-lower-electrode type light-emitting element, and a flip-chip type light-emitting element.

The frame part 23 is provided on the substrate 21. The frame part 23 is adhered to the substrate 21. The frame part 23 is in a frame shape and surrounds the light-emitting elements 22. The profile of the frame part 23 in the case of viewing from the direction along the central axis 1a of the vehicle lighting device 1 can be substantially rectangular. The frame part 23, for example, can be arranged in a rectangular columnar shape. In such case, considering the symmetry with respect to the central axis 1a of the vehicle lighting device 1, as shown in FIG. 3, the profile of the frame part 23 may be square. The corners of the square shape may be rounded or chamfered.

The frame part 23, for example, is formed from resin. The resin, for example, can be a thermoplastic resin such as polybutylene terephthalate (PBT), polycarbonate (PC), PET, nylon, polypropylene (PP), polyethylene (PE), polystyrene (PS), etc.

The frame part 23 has a function of defining a forming range of the sealing part 24 and a function of a reflector.

Therefore, in order to facilitate reflectivity, the frame part 23 can include at least one of a white resin and light scattering particles (e.g., particles of titanium oxide). If the frame part 23 is provided, the efficiency of using the light emitted from the light-emitting elements 22 can be facilitated. In addition, since the range in which the sealing part 24 is formed can be reduced, the size of the light emitting module 20 can be reduced, and the size of the vehicle lighting device 1 can be reduced.

The sealing part 24 is provided on the inner side of the frame part 23. The sealing part 24 is provided to cover the region surrounded by the frame part 23. The sealing part 24 is provided to cover the light-emitting elements 22. The sealing part 24 includes a resin having a light transmissive property. The scaling part 24, for example, is formed by filling resin to the inner side of the frame part 23. The filling of the resin, for example, can be carried out by using a dispenser. The filling resin, for example, is a silicone resin.

Also, the sealing part 24 can contain a phosphor. The phosphor, for example, can be a yttrium-aluminum-garnet-based (YAG-based) phosphor, etc. However, the type of the phosphor can be changed as appropriate so as to achieve a predetermined emitted light color in accordance with the purpose of the vehicle lighting device 1.

In addition, a reflective layer can also be provided on a region (a region where the light-emitting elements 22 are not provided) where the substrate 21 is exposed on the inner side of the frame part 23. The reflective layer can be formed by filling a resin with a high reflectivity in the region where the substrate 21 is exposed on the inner side of the frame part 23. The filling of the resin with a high reflectivity, for example, can be carried out by using a dispenser. The reflective layer, for example, can include at least one of a white resin and light scattering particles (e.g., particles of titanium oxide). If the reflective layer is provided, the efficiency of using the light emitted from the light-emitting elements 22 can be facilitated.

The circuit element 25 can be arranged as a passive element or an active element used to construct a light emitting circuit having the light-emitting elements 22. The circuit element 25, for example, is provided on the periphery of the frame part 23 and electrically connected with the wiring pattern 21a. The circuit element 25 is electrically connected with the light-emitting elements 22 via the wiring pattern 21a. The circuit element 25, for example, may also be provided in a lighting circuit, etc., provided outside the vehicle lighting device 1. In this way, the configuration of the light emitting module 20 can be simplified, so the manufacturing cost of the vehicle lighting device 1 can be reduced. However, if the circuit element 25 is provided at the light emitting module 20, it becomes easy to protect the light emitting module 20 and make the light emitting module 20 multi-functional.

The circuit element 25, for example, can be a resistor 25a, a protection element 25b, and a control element 25c, etc.

However, the types of the circuit element 25 are not limited to those that are exemplified, and can be changed as appropriate in accordance with the configuration of the light emitting circuit having the light-emitting elements 22. For example, in addition to those described above, the circuit element 25 may also be a capacitor, a positive thermistor, a negative thermistor, an inductor, a serge absorber, a varistor, an integrated circuit, an arithmetic element, etc.

The resistor 25a is provided on the substrate 21. The resistor 25a is electrically connected with the wiring pattern 21a. The resistor 25a, for example, can be a surface-mounted resistor, a resistor having a lead wire (metal oxide film resistor), a film resistor formed by using a screen printing method, etc. The resistor 25a shown in FIG. 1 is a surface-mounted resistor.

Here, since the forward voltage characteristics of the light-emitting element 22 exhibit variation, when the applied voltage between an anode terminal and a ground terminal is constant, variation occurs in the brightness (luminous flux, luminance, luminous intensity, illuminance) of the light emitted from the light-emitting element 22. Therefore, the value of the current flowing through the light-emitting element 22 is arranged within a predetermined range by using the resistor 25a connected in series with the light-emitting elements 22, so that the brightness of the light emitted from the light-emitting elements 22 falls within a specific range. In such case, by varying the resistance value of the resistor 25a, the value of the current flowing through the light-emitting elements 22 falls within the predetermined range.

In the case where the resistor 25a is a surface-mounted resistor or a resistor having a lead wire, the resistor 25a having a suitable resistance value is selected in accordance with the forward voltage characteristics of the light-emitting element 22. In the case where the resistor 25a is a film resistor, if a portion of the resistor 25a is removed, the resistance value can be increased. For example, if the film resistor is irradiated with laser light, a portion of the film resistor can be easily removed. The quantity, arrangement, size, etc., of the resistor 25a are not limited to those exemplified above, and can be changed as appropriate in accordance with the quantity, the specification, etc., of the light-emitting elements 22.

The protection element 25b is provided on the substrate 21. The protection element 25b is electrically connected with the wiring pattern 21a. The protection element 25b, for example, is provided so that a reverse voltage is not applied to the light-emitting elements 22 and so that pulse noise from the reverse direction is not applied to the light-emitting elements 22. The protection element 25b, for example, can be a diode. The protection element 25b shown in FIG. 1 is a surface-mounted diode.

The control element 25c is provided on the substrate 21. The control element 25c is electrically connected with the wiring pattern 21a. The control element 25c, for example, is provided to switch the voltage applied to the light-emitting elements 22. The control element 25c, for example, can be arranged as a transistor or an integrated circuit. The control element 25c shown in FIG. 1 is a surface-mounted transistor.

The lens 26 is provided on the sealing part 24. The lens 26, for example, is a convex lens. The lens 26 is bonded to at least one of the sealing part 24 and the frame part 23. The surface of the lens 26 on the side of the sealing part 24 is in close contact with the sealing part 24. The lens 26, for example, can be adhered to an end part of the frame part 23 on the side opposite to the side of the substrate 21. The planar shape of the lens 26 (the shape in the case of viewing from the direction along the central axis 1a of the vehicle lighting device 1) can be arranged to be the same as the profile of the frame part 23. The surface shape of the lens 26, for example, can be arranged in a substantially rectangular shape. In such case, considering the symmetry with respect to the central axis 1a of the vehicle lighting device 1, as shown in FIG. 3, the planar shape of the lens 26 may be square. The corners of the square shape may be rounded or chamfered.

The lens 26 can also be omitted. However, if the lens 26 is provided, the light extraction efficiency can be facilitated, so the light emitting efficiency can be facilitated. If the light emitting efficiency can be facilitated, it is easy to obtain a desired light beam.

The power supply part 30, for example, has multiple power supply terminals 31 and a holding part 32.

The power supply terminals 31 can be rod-shaped. The power supply terminals 31, for example, are provided side-by-side in a predetermined direction. End parts on one side of the power supply terminals 31 protrude from a bottom surface 11al of the concave part 11a. The end parts on one side of the power supply terminals 31 are soldered with the wiring pattern 21a provided on the substrate 21. End parts on the other side of the power supply terminals 31 are exposed inside a hole of the connector holder 15. The connector 105 is fit with the power supply terminals 31 exposed inside the hole of the connector holder 15. The power supply terminals 31, for example, are formed from a metal such as copper alloy. The shape, arrangement, material, etc., of the power supply terminals 31 are not limited to those exemplified above, but can be changed as appropriate.

As described above, the socket 10 may be formed from a material with a high thermal conductivity. However, materials with a high thermal conductivity may be electrically conductive. For example, metals such as aluminum alloy or resins with a high thermal conductivity that include fillers using carbon are electrically conductive. Therefore, the holding part 32 is provided to insulate between the power supply terminals 31 and the socket 10 that is electrically conductive. In addition, the holding part 32 has a function of holding the power supply terminals 31. In the case where the socket 10 is formed from a resin (e.g., such as a resin with a high thermal conductivity that includes a filler using aluminum oxide) having a high thermal conductivity while exhibiting an insulating property, the holding part 32 can be omitted. In this case, the socket 10 holds the power supply terminals 31. The holding part 32, for example, is formed from a resin exhibiting an insulating property. The holding part 32, for example, can be press-fit with a hole provided in the socket 10 or adhered to the inner wall of the hole.

The heat transfer part 40 exhibits a plate shape and is provided between the socket 10 and the light emitting module 20 (substrate 21). For example, as shown in FIGS. 1 and 2, the heat transfer part 40 can be adhered to the bottom surface 11al of the concave part 11a. In addition, the heat transfer part 40 may also be adhered to the inside of a concave part provided on the bottom surface 11al of the concave part 11a. In addition, the heat transfer part 40 may also be adhered onto a convex pedestal provided on the bottom surface 11al of the concave part 11a. The adhesive agent adhering the heat transfer part 40 and the socket 10 may be an adhesive agent with a high thermal conductivity. For example, the adhesive agent can be the same as the adhesive agent that adheres the light emitting module 20 (substrate 21) and the heat transfer part 40.

In addition, through insert molding, the heat transfer part 40 and the socket 10 can be integrally formed. In addition, the heat transfer part 40 may also be installed to the socket 10 via a layer containing thermally conductive grease (heat dissipation grease). The thermally conductive grease, for example, is grease in which a filler using an inorganic material is mixed with modified silicone.

The heat transfer part 40 is provided to easily transfer heat generated in the light emitting module 20 to the socket 10. Therefore, the heat transfer part 40 is formed from a material with a high thermal conductivity. For example, the heat transfer part 40 can be formed by metal such as aluminum, aluminum alloy, copper, copper alloy, etc.

It is noted that, for example, in the case where the heat generated in the light emitting module 20 is relatively little or the case where the socket 10 is formed from metal, the heat transfer part 40 may be omitted. In the case where the heat transfer part 40 is omitted, the light emitting module 20 (substrate 21) is adhered to the bottom surface 11al of the concave part 11a, etc.

Here, as will be described in the following, the vehicle lighting device 1 is installed to a housing 101 provided in the vehicle lighting fixture 100. In addition, the light emitted from the vehicle lighting device 1 is emitted into an optical element 103 provided in the vehicle lighting fixture 100. Therefore, the luminance distribution of a portion from which the light of the vehicle lighting device 1 is emitted has a great influence on the optical design of the optical element 103 provided in the vehicle lighting fixture 100. In such case, if the lens 26 is not provided, the portion from which the light of the vehicle lighting device 1 is emitted can be arranged as a region on the inner side of the frame part 23 (the end surface of the sealing part 24 on the side opposite to the side of the substrate 21). If the lens 26 is provided, the portion from which the light of the vehicle lighting device 1 is emitted can be arranged as the light emitting surface of the lens 26. For example, in the case where the lens 26 is a convex lens, the portion from which the light of the vehicle lighting device 1 is emitted can be a curved surface of the lens 26 on the side opposite to the side of the substrate 21.

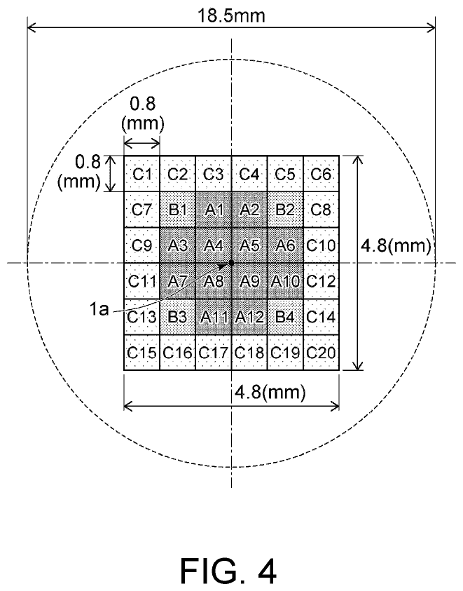

FIG. 4 is a view illustrating evaluation of the luminance distribution of the portion from which the light of the vehicle lighting device 1 is emitted.

As shown in FIG. 4, the luminance distribution can be evaluated in a square region with a side of 4.8 mm and with the central axis 1a of the vehicle lighting device 1 as the center. In such case, the square region with a side of 4.8 mm is equally divided into 36, and by obtaining the light emitting intensity in each of the equally divided 36 regions (a square region with a side of 0.8 mm), the luminance distribution of the portion from which the light of the vehicle lighting device 1 is emitted can be evaluated.

For example, the light emitting intensity in each region may fall within ranges as follows:

$$3 \% < A < 10 \%$$

$$3 \% < B < 10 \%$$

$$C < 2 \%$$

$$70 \% < A + B$$

$$90 \% < A + B + C$$

The light emitting intensity in a region with a diameter of 18.5 mm and with the central axis 1a of the vehicle lighting device 1 as the center is set as 100%.

In addition, it is defined that A=(light emitting intensity in each of regions A1 to A12/light emitting intensity in the region with a diameter of 18.5 mm)×100%. That is, A serves to evaluate the luminance in the vicinity of the central axis 1a of the vehicle lighting device 1.

It is defined that B=(light emitting intensity in each of regions B1 to B4/light emitting intensity in the region with a diameter of 18.5 mm)×100%. That is, B serves to evaluate the luminance of the end parts in the diagonal directions in the region in the vicinity of the central axis 1a of the vehicle lighting device 1.

It is defined that C=(light emitting intensity in each of regions C1 to C20/light emitting intensity in the region with a diameter of 18.5 mm)×100%. That is, C serves to evaluate the luminance in the peripheral region of the portion from which the light of the vehicle lighting device 1 is emitted.

In addition, in order to evaluate the luminance distribution in the square region with a side of 4.8 mm, the dimension of a side of the portion from which the light of the vehicle lighting device 1 is emitted in the case of viewing from the direction along the central axis 1a of the vehicle lighting device 1 can be equal to or less than 4.8 mm. For example, in the case of viewing in the direction along the central axis 1a of the vehicle lighting device 1, the dimension of a side of the inner side of the frame part 23 can be equal to or less than 4.8 mm.

In such case, since “C<2%”, “90%<A+B+C (70%<A+B)” as described above, the light emitting intensity of the regions A1 to A12 and the light emitting intensity of the regions B1 to B4 have a greater influence on the luminance distribution of the portion from which the light of the vehicle lighting device 1 is emitted than the light emitting intensity of the regions C1 to C20. Therefore, even if the frame part 23 is provided on the regions C1 to C20, the luminance distribution of the portion from which the light of the vehicle lighting device 1 is emitted can be properly evaluated. In addition, if the dimension of the portion from which the light of the vehicle lighting device 1 is emitted is reduced in the case of viewing from the direction along the central axis 1a of the vehicle lighting device 1, a desired luminance distribution is easily achieved.

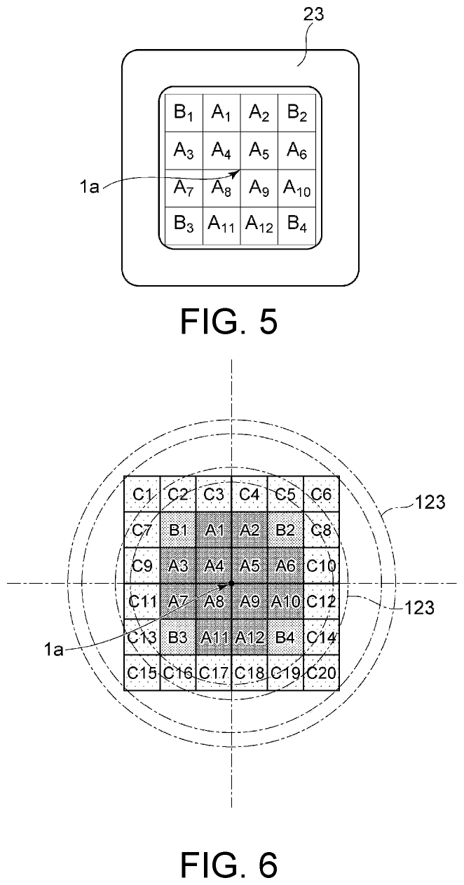

FIG. 5 is a schematic plan view illustrating a case where the frame part 23 is provided on the regions C1 to C20.

As shown in FIG. 5, in the case where the frame part 23 is provided on the regions C1 to C20, the dimension of a side of the inner side of the frame part 23 when viewing from the direction along the central axis 1a of the vehicle lighting device 1 can be set as 3.2 mm or more and 4.8 mm or less.

In addition, although the above describes the case where the profile of the frame part 23 in the case of viewing from the direction along the central axis 1a of the vehicle lighting device 1 is square, the same is applicable to the case where the profile of a frame part 123 is circular. In such case, the frame part 123 can be in a cylindrical shape. In the case where the profile of the frame part 123 is circular, the planar shape of the lens (the shape in the case of viewing from the direction along the central axis of the vehicle lighting device 1) can be arranged as circular.

FIG. 6 is a schematic plan view illustrating a case where the profile of the frame part 123 is circular.

As shown in FIG. 6, the inner wall of the frame part 123 can be provided on the corner parts of the regions C1, C6, C15, C20. In this way, the luminance distribution in the regions A1 to A12, the regions B1 to B4, and the regions C1 to C20 can be evaluated.
In addition, the inner wall of the frame part 123 can be provided on the corner parts of the regions B1, B2, B3, B4. In this way, the luminance distribution in the regions A1 to A12 and the regions B1 to B4 can be evaluated.
That is, in the case where the profile of the frame part 123 is circular, the inner diameter (diameter dimension) of the frame part 123 can be set as 4.5 mm or more and 6.8 mm or less.

Since the luminance distribution is evaluated in a square region, when the profile of the frame part 123 is circular, the area of the region out of the evaluation target on the inner side of the frame part 123 is increased. In such case, if the profile of the frame part 123 is square, the area of the region out of the evaluation target on the inner side of the frame part 123 can be reduced. Therefore, the profile of the frame part 123 may be square.

### (Vehicle Lighting Fixture)

In an embodiment of the invention, the vehicle lighting fixture 100 including the vehicle lighting device 1 can be provided. Both of the above description about the vehicle lighting device 1 and the modified examples of the vehicle lighting device 1 (e.g., those in which a person skilled in the art appropriately adds, deletes, or changes the design of components and which include the characteristics of the invention) can be applied to the vehicle lighting fixture 100.

In the following, as an example, a case where the vehicle lighting fixture 100 is a front combination light provided in an automobile is described. However, the vehicle lighting fixture 100 is not limited to a front combination light provided in an automobile. The vehicle lighting fixture 100 may also be a vehicle lighting fixture provided in an automobile or a railroad vehicle, etc.

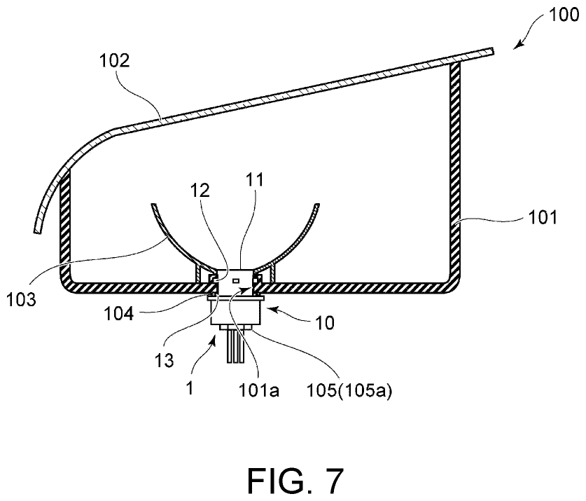

FIG. 7 is a schematic partial cross-sectional view illustrating the vehicle lighting fixture 100.

As shown in FIG. 7, the vehicle lighting fixture 100, for example, is provided with the vehicle lighting device 1, the housing 101, a cover 102, the optical element 103, a seal member 104, and the connector 105.

The vehicle lighting device 1 is installed to the housing 101. The housing 101 holds the installation part 11. The housing 101 is in a box shape in which an end part side is open. The housing 101, for example, is formed from a resin through which light does not pass. On the bottom surface of the housing 101, an installation hole 101a is provided. Portions of the installation part 11 where the bayonets 12 are provided are inserted into the installation hole 101a. On the periphery of the installation hole 101a, a concave part is provided. The bayonets 12 provided on the installation part 11 are inserted into the concave part. Although the case where the installation hole 101a is directly provided on the housing 101 is exemplified, it may also be that an installation member having the installation hole 101a is provided on the housing 101.

At the time of installing the vehicle lighting device 1 to the vehicle lighting fixture 100, the portions of the installation part 11 where the bayonets 12 are provided are inserted into the installation hole 101a, and the vehicle lighting device 1 is rotated. Then, for example, the bayonets 12 are held at the fitting part provided on the periphery of the installation hole 101a. Such installation method is referred to as “twist lock”.

The cover 102 is provided to block the opening of the housing 101. The cover 102 is formed from a light transmissive resin, etc. The cover 102 can exhibit a function of a lens, etc.

The light emitted from the vehicle lighting device 1 is emitted into the optical element 103. The optical element 103 reflects, diffuses, guides, collects, the light emitted from the vehicle lighting device 1 and forms the predetermined light distribution pattern. For example, the optical element 103 shown in FIG. 7 is a reflector. In this case, the optical element 103 reflects the light emitted from the vehicle lighting device 1 and forms the predetermined light distribution pattern.

The seal member 104 is provided between the flange 13 and the housing 101. The seal member 104 exhibits a ring shape, and is formed from a material having an elastic property, such as rubber or silicone resin.

At the time when the vehicle lighting device 1 is installed to the vehicle lighting fixture 100, the seal member 104 is sandwiched between the flange 13 and the housing 101. Therefore, by using the seal member 104, the internal space of the housing 101 can be sealed. In addition, due to the elastic force of the seal member 104, the bayonets 12 are pressed against the housing 101. Therefore, the vehicle lighting device 1 can be prevented from being detached from the housing 101.

The connector 105 is fit with the end parts of the power supply terminals 31 exposed inside the connector holder 15. The lighting circuit, etc., is electrically connected with the connector 105. Therefore, by fitting the connector 105 with the end parts of the power supply terminals 31, the light-emitting elements 22 can be electrically connected with the lighting device, etc.

In addition, the seal member 105a is provided at the connector 105. At the time when the connector 105 having the seal member 105a is inserted into the connector holder 15, the inside of the connector holder 15 is sealed in a water-tight manner.

Although some embodiments of the invention have been illustrated above, these embodiments are presented as examples and are not intended to limit the scope of the invention. These novel embodiments can be implemented in various other forms, and various omissions, replacements, changes, etc., can be made without departing from the scope of the invention. These embodiments and their modifications are included in the scope and gist of the invention, and are included in the scope of the invention described in the claims and equivalents thereof. Moreover, each of the above-described embodiments can be implemented in combination with each other.

Additional remarks regarding the above-described embodiment are shown below.

### APPENDIX 1

A vehicle lighting device, includes: a socket; a substrate, provided on a side of an end part of the socket; multiple light-emitting elements, provided on the substrate; a frame part, having a frame shape, provided on the substrate, and surrounding the light-emitting elements; and a sealing part, provided on an inner side of the frame part and covering the light-emitting elements. In a case of viewing from a direction along a central axis of the vehicle lighting device, a profile of the frame part is square or circular, in a case where the profile of the frame part is square, a dimension of a side on the inner side of the frame part is 3.2 mm or more and 4.8 mm or less, and in a case where the profile of the frame part is circular, an inner diameter of the frame part is 4.5 mm or more and 6.8 mm or less.

### APPENDIX 2

In the vehicle lighting device according to Appendix 1, five light-emitting elements are provided, in the case of viewing from the direction along the central axis of the vehicle lighting device, one of the light-emitting elements is provided at a position of the central axis of the vehicle lighting device, and four of the light-emitting elements are provided at rotationally symmetrical positions with the central axis of the vehicle lighting device as a center.

### APPENDIX 3

The vehicle lighting device according to Appendix 1 or 2 further includes a lens provided on the sealing part.

### APPENDIX 4

In the vehicle lighting device according to any one of Appendices 1 to 3, the frame part includes at least one of a white resin and light scattering particles.

### APPENDIX 5

A vehicle lighting fixture, includes
the vehicle lighting device according to any one of Appendices 1 to 4; and a housing to which
the vehicle lighting device is installed.

1. A vehicle lighting device, comprising:
a socket;
a substrate, provided on a side of an end part of the socket;
a plurality of light-emitting elements, provided on the substrate;
a frame part, having a frame shape, provided on the substrate, and surrounding the light-emitting elements; and
a sealing part, provided on an inner side of the frame part and covering the light-emitting elements,
wherein viewing from a direction along a central axis of the vehicle lighting device, a profile of the frame part is square or circular,
in a case where the profile of the frame part is square, a dimension of a side on the inner side of the frame part is 3.2 mm or more and 4.8 mm or less, and
in a case where the profile of the frame part is circular, an inner diameter of the frame part is 4.5 mm or more and 6.8 mm or less,
wherein
a first region is stipulated, at a light output side of the vehicle lighting device, by a square that is orthogonal to the central axis of the vehicle lighting device, the square having a side of 4.8 mm,
a center of the first region overlaps with the central axis of the vehicle lighting device,
the first region is equally divisible into 36 second regions,
each second region having a side of 0.8 mm,
wherein
the inner side of the frame part is positioned to overlap with 20 second regions that are lined up along sides of the first region among the 36 second regions.

2. The vehicle lighting device as claimed in claim 1, wherein five light-emitting elements are provided,
viewing from the direction along the central axis of the vehicle lighting device, one of the light-emitting elements is provided at a position of the central axis of the vehicle lighting device, and four of the light-emitting elements are provided at rotationally symmetrical positions with the central axis of the vehicle lighting device as a center.

3. The vehicle lighting device as claimed in claim 1, further comprising a lens provided on the sealing part.

4. The vehicle lighting device as claimed in claim 1, wherein the frame part comprises at least one of a white resin and light scattering particles.

5. A vehicle lighting fixture, comprising:
the vehicle lighting device as claimed in claim 1; and
a housing to which the vehicle lighting device is installed.
